(19) United States
(12) Patent Application Publication
(10) Pub. No.: US 2025/0323459 A1
(43) Pub. Date: Oct. 16, 2025

(54) WATERPROOF QUICK COUPLING MECHANISM FOR SWITCH DEVICE

(71) Applicants: SWITCHLAB INC., NEW TAIPEI CITY (TW); SWITCHLAB (SHANGHAI) CO., LTD., SHANGHAI CITY (CN); GAOCHENG ELECTRONICS CO., LTD., GUANGDONG PROVINCE (CN)

(72) Inventors: CHIH YUAN WU, NEW TAIPEI CITY (TW); WEN BING HSU, NEW TAIPEI CITY (TW)

(21) Appl. No.: 19/172,870

(22) Filed: Apr. 8, 2025

(30) Foreign Application Priority Data
Apr. 15, 2024 (TW) 113203702

(51) Int. Cl. H01R 13/639; H01R 13/52

(52) U.S. Cl. CPC H01R 13/639; H01R 13/5202

(57) ABSTRACT

A waterproof quick coupling mechanism for switch device includes a base portion for receiving wiring components, a coupler rotatably assembled to the base portion, and an enclosure integrally covering the base portion. The coupler is an annular structure and provided with retaining structures and anti-loosening structures. When the retaining structures of the coupler are engaged with mating retaining zones on a switch device and one of the anti-loosening structures of the coupler gets into contact with a stopper and a limiting section provided on the base portion to set the switch device and the coupler in a locked state, a conductor can be quickly and securely connected to the switch device via the waterproof coupling mechanism. With these arrangements, it is able to overcome the problems of troublesome wiring, assembling and maintenance, dust and water invasion, etc. that would otherwise occur in the conventional switch device with quick coupler.

### FIELD OF THE INVENTION

The present invention relates to a waterproof quick coupling mechanism for switch device, and more particularly, to an assembly that includes a coupler, a base portion, and an enclosure for covering the entire base portion to achieve quick connection of switch components (or wiring) with an external conductor.

### BACKGROUND OF THE INVENTION

It is a known technique to mount a switch device on an operation panel, a distribution board, or other similar components of an electric machine, electronic device, auto-control equipment, etc. to connect it with wirings and circuits, and/or use it with pushbuttons or knobs for controlling electrical connection and disconnection of wiring circuits or conductors.

In the practices of wiring and assembling a prior art switch device, there are usually 3˜8 contact elements or contact pieces provided on a wiring module of the switch device to protrude from a tail portion of the switch device. Depending on actual need in use, an operator may plug external conductors into or weld them to matched protruded contact elements one by one to form an electrical connection state.

An issue about the structure and practical application of the conventional switch device is the time consuming and troublesome operation of plugging or welding external conductors to the switch device one by one. Particularly, in the case of repair, maintenance or replacement of the switch device, desoldering must be done by the operator for each of the conductors one by one and the original location pairing between each contact element and each corresponding external conductor must be recorded. Since complicate work procedures are involved, a lot of time is consumed in the connection and disconnection of conductors to and from the conventional switch device, the working efficiency thereof is very low.

To overcome the above problem, a quick coupler is applied to the connection of the prior art switch device with conductors. The quick coupler is provided with retaining structures and a conductor module. An operator can manipulate the retaining structures on the quick coupler, such that the quick coupler is snap fitted to the switch device, allowing the contact elements on the switch device to connect with the conductor module quickly.

An issue about the conventional switch device with the retaining structures and the practical operation thereof is that the switch device and the quick coupler tend to become loosened or separated from each other due to external factors, such as man-made negligence or unexpected collision, or due to frequent vibration of the electric appliance on which the switch device is mounted.

Another issue about the structure of the conventional switch device and the practical operation thereof is that the switch device connected to the quick coupler could not effectively stop moisture, water, duct or other similar foreign materials from invading into and accumulating in the switch device and the quick coupler via gaps between them to thereby undesirably affect the operation stability or safety in use of the switch device.

Generally, the above discussion discloses the usage and structural design of the conventional switch device, the quick coupler, or other related components. In the event the past structures and applications of the conventional switch device with the quick coupler can be redesigned to change its manner of use and increase its application effect, an improved quick coupling mechanism for switch device distinct from the conventional switch device with quick coupler can be provided. For example, in the premise of being simple in structure and easy to operation to facilitate convenient repair and maintenance by operators, the improved quick coupling mechanism for switch device should also take the following issues into consideration:
(1) providing a quick coupler structure for switch device that can be securely connected to the switch device and allows an operator to quick disconnect it from the switch device, and can prevent the switch device from loosening or separating from the quick coupler due to external factors or frequent vibration of the electric appliance having the switch device mounted thereon; and
(2) providing a quick coupler structure for switch device that can effectively prevent moisture, water, dust and other similar foreign materials from invading into or accumulating in the quick coupler and the switch device via gaps between them, in order to ensure stable operation and save use of the switch device.

All these issues have not been taught or disclosed in the past.

### SUMMARY OF THE INVENTION

A primary object of the present invention is to provide a waterproof quick coupling mechanism for switch device that is easy to operate and maintain and is water/dust proof. The waterproof quick coupling mechanism according to the present invention includes a base portion for receiving wiring components therein, a coupler rotatably connected to the base portion, and an enclosure integrally covering the base portion. The coupler is in the form of a ring and provided with retaining structures and anti-loosening structures. When the retaining structures of the coupler are engaged with mating retaining zones on a switch device and one anti-loosening structure of the coupler gets into contact with stoppers or limiting sections provided on the base portion, the switch device and the coupler is set to an unlocked or locked state, such that a conductor can be quickly and securely connected to the switch device via the waterproof coupling mechanism to overcome the problems of troublesome wiring and assembling as would be found in the conventional switch device.

In an embodiment of the present invention, the retaining structures are threaded or elongated rib-shaped structures, the anti-loosening structures are protruded structures. The switch device is provided with mating retaining zones in the form of threaded or elongated rib-shaped structure corresponding to the retaining structures of the coupler, such that the retaining structures of the coupler can be quickly connected to or disconnected from the switch device. Further, the base portion is provided with primary and secondary stoppers corresponding to the anti-loosening structures on the coupler, in order to limit the angle of rotation or the range of movement of the coupler.

### BRIEF DESCRIPTION OF THE DRAWINGS

FIG. 1 is an assembled perspective view showing a waterproof quick coupling mechanism for switch device according to a preferred embodiment of the present invention;

FIG. 2 is an exploded view of FIG. 1, showing a switch device, a coupler, a base portion, and an enclosure included in the preferred embodiment of the present invention;

FIG. 3 is a side view of the present invention, wherein the imaginary lines depict an L-shaped structure can be formed by a tail portion of the enclosure;

FIG. 4 is a sectional side view of the present invention, which depicts the engagement of retaining structures of the coupler with mating retaining zones of the switch device and the connection of contact elements of the switch device with wiring components received in the base portion;

FIG. 5 is a cross sectional view of the present invention depicting the switch device and the coupler are located at an unlocked position or state;

FIG. 6 is an operational example based on FIG. 5 showing the coupler is turned until the switch device and the coupler are located at a locked position or state;

FIG. 7 is an exploded perspective view showing a derivative embodiment of the present invention;

FIG. 8 is a side view of FIG. 7 showing the engagement of the retaining structures of the coupler with the mating retaining zones of the switch device; wherein the imaginary lines depict an L-shaped structure can be formed by the tail portion of the enclosure;

FIG. 9 is an exploded perspective view of an modified embodiment of the present invention showing the base portion thereof is provided with a watertight ring and a locating washer;

FIG. 10 is a sectional side view of FIG. 9 showing an assembly of the coupler and the base portion with the locating washer and the watertight ring, and the structure formed by the connection of the contact elements of the switch device with the wiring components in the base portion; and

FIG. 11 is an enlarged view of the circled area of FIG. 10 showing the assembly of the coupler and the base portion with the locating washer and the watertight ring.

### DETAILED DESCRIPTION OF THE PREFERRED EMBODIMENTS

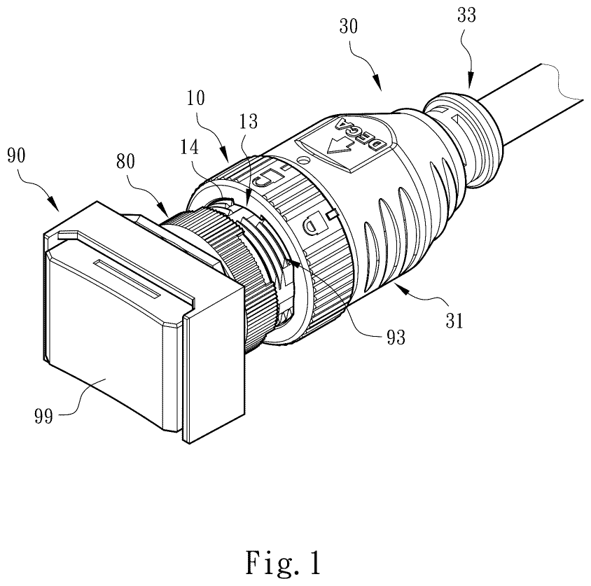

Please refer to FIGS. 1 to 4. A waterproof quick coupling mechanism for switch device according to a preferred embodiment of the present invention includes a coupler, a base portion, and an enclosure, which are generally denoted by reference numeral 10, 20, and 30, respectively. The waterproof quick coupling mechanism can be connected to a switch device 90 via the coupler 10, such that the switch device 90 can be electrically connected with an external conductor for controlling ON or OFF of wiring circuits or conductors.

It is noted directions viewed in front of the drawings are determined as reference directions for the directional terms of upper end (or section), lower end (or section), left side, right side, front end (or section), rear end (or section), outer side, inner side, etc. being used in the present invention.

As shown in the drawings, the switch device 90 includes an operation section 99 and a shell 98 assembled to the operation section 99. The shell 98 internally receives a conductive module and a plurality of contact elements 96 outward protruded from a rear end of the shell 98. The operation section 99 may be selected from the group consisting of a pushbutton, a knob, and other equivalent structures, and can be pushed or rotated by an operator to control the switch device 90 to a closed-circuit state or an open-circuit state. The shell 98 is provided on an outer surface with several turns of threads 97 for meshing with a fixing ring 80, such that the switch device 90 can be locked to a base plate or a control panel.

Basically, the switch device 90 includes the operation section 99, the shell 98, the conductive module and the contact elements 96, and can be locked to a base plate or a panel using the fixing ring 80. Since these are known art, they are not described in detail herein.

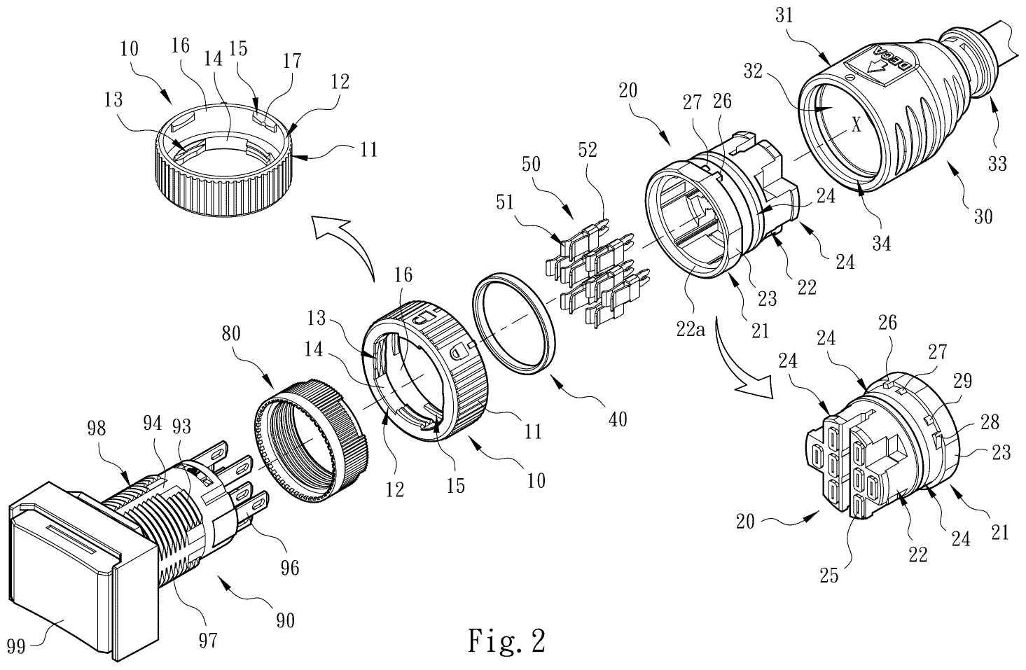

Please refer to FIGS. 2, 3, and 4. The coupler 10, the base portion 20, and the enclosure 30 together define an axis X. The coupler 10 is an annular structure having an outer wall 11 and an inner wall 12. The outer wall 11 is provided with marks indicating an unlocked position or symbol and a locked position or symbol, which help the operator to easily identify the position the coupler 10 is currently assembled to the switch device 90. The inner wall 12 of the coupler 10 is provided along a front area (i.e. the left area when viewing in front of the drawings) with circumferentially spaced retaining structures 13, which are protruded toward the axis X, and recesses 14 respectively located between any two adjacent retaining structures 13. The inner wall 12 of the coupler 10 is provided along a rear area (i.e. the right area when viewing in front of the drawings) with circumferentially spaced anti-loosening structures 15 and secondary recesses 16 respectively located between any two adjacent anti-loosening structures 15.

In the preferred embodiment, there is a plurality of retaining structures 13 equally spaced on the coupler 10. For example, the number of the retaining structures 13 may be four (4). The retaining structures 13 are partially in the form of several threads. There is also a plurality of anti-loosening structures 15 equally spaced on the coupler 10. The number of the anti-loosening structures 15 is corresponding to that of the retaining structures 13 and may be four (4), for example. The anti-loosening structures 15 are respectively an elongated and radially inward protruded structure. At least one of the anti-loosening structures 15 located corresponding to the locked symbol and/or the unlocked symbol is formed with a radially outward recessed or a radially inward protruded fitting section 17.

In practical implementation, the retaining structures 13 of the coupler 10 are correspondingly screwed to mating retaining zones 93 of the switch device 90. The mating retaining zones 93 are partially in the form of threads and a non-threaded section 94 is formed between any two adjacent mating retaining zones 93. With these arrangements, the retaining structures 13 of the coupler 10 can be quickly connected to or disconnected from the switch device 90 as will be described in more detail below.

As shown in the drawings, the base portion 20 includes a neck section 21 having a relatively large diametrical size and a tummy section 22 having a diametrical size smaller than that of the neck section 21. The neck section 21 has flat faces 23 formed on its outer surface to allow the anti-loosening structures 15 to pass over, so that the coupler 10 can be more easily assembled to the base portion 20. Further, the base portion 20 is provided in an area, at where the neck section 21 is connected to the tummy section 22, with a radially outward protruded primary stopper 26 and a radially outward protruded secondary stopper 28 corresponding to one of the anti-loosening structures 15 of the coupler 10 to limit an angle of rotation or a range of movement of the coupler 10.

In an operable embodiment, the base portion 20 is provided between the primary stopper 26 and the secondary stopper 28 with a primary limiting section 27 and a second limiting section 29 that can be a radially outward protruded or a radially inward recessed structure corresponding to the fitting section 17 of the coupler 10. A shoulder section 22a is formed between the neck section 21 and the tummy section 22. A sealing ring 40 can be mounted in the neck section 21 to abut against the shoulder section 22a. After the coupler 10 and the base portion 20 are assembled, the sealing ring 40 is sealed between the coupler 10 and the base portion 20.

As shown in the drawings, wiring components 50 are received in the tummy section 22 of the base portion 20. The wiring components 50 respectively have an end (i.e. a front end when viewing in front of the drawings) configured as a spring clip structure 51 for direct clipping on one of the contact elements 96 of the switch device 90; and another end (i.e. a rear end when viewing in front of the drawings) configured as a clamp structure (or a clamping piece structure) 52 for clamping or welding to an external conductor 85.

Specifically, the tummy section 22 of the base portion 20 has cuts 25 formed on a bottom or underside thereof, allowing the clamp structures 52 of the wiring components 50 to extend therethrough to an outer side of the tummy section 22. During an in-plant manufacturing stage, an operator may, depending on actual need in use, movably connect the clamp structure 52 to the conductor 85. Further, the tummy section 22 is formed around its outer surface with scarf joining sections 24, which can be in the form of corrugated and/or recessed structure.

In the preferred embodiment, the enclosure 30 is configured to integrally cover the entire base portion 20 or the tummy section 22 of the base portion 20. Alternatively, the enclosure 30 may cover the base portion 20 or the tummy section 22 of the base portion 20 by way of insert molding. The enclosure 30 includes a head portion 31, a tail portion 33 connected to the head portion 31, and an internal space 32 defined in the head portion 31 for receiving the tummy section 22 of the base 20 therein. The head portion 31 of the enclosure 30 has a fitting structure 34 formed on an inner wall thereof for engaging with the scarf joining sections 24 of the base portion 20, such that the enclosure 30 fixedly covers the tummy section 22 of the base portion 20 to provide a whole protection to the tummy section 22.

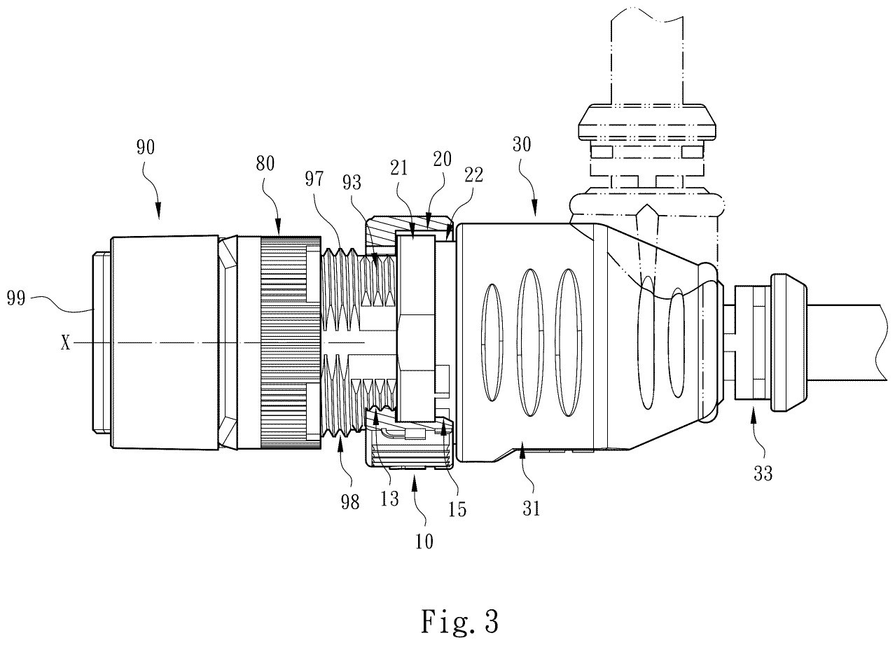

FIG. 3 shows that the tail portion 33 of the enclosure 30 is designed to extend parallel to the axis X. Imaginary lines in FIG. 3 indicate the enclosure 30 may be otherwise designed to have an L-shaped tail portion 33.

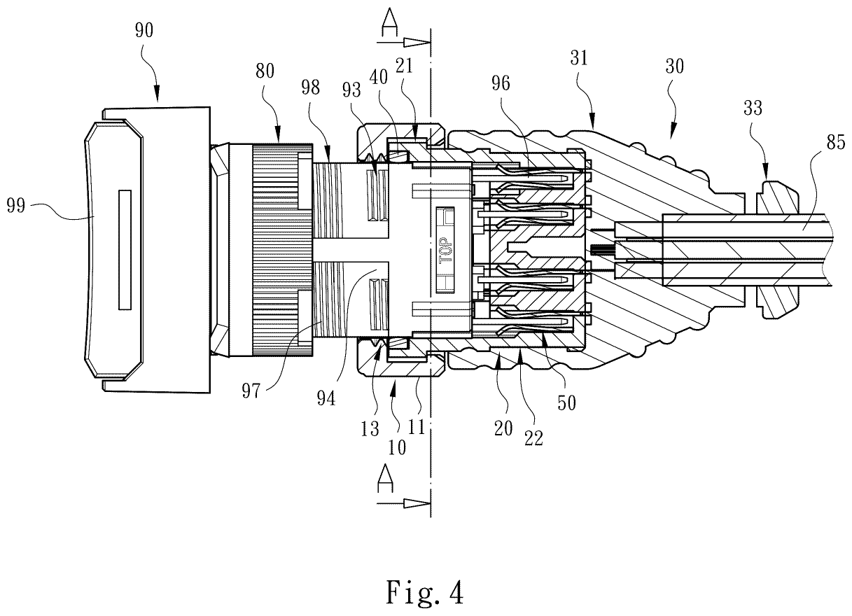

Please refer to FIGS. 3 and 4. As shown, the tail portion 33 of the enclosure 30 may also be designed to be able to enclose the external conductor 85. Therefore, the enclosure 30, which covers the base portion 20 or the tummy section 22 of the base portion 20 and the conductor 85, and the coupler 10, which is assembled with the sealing ring 40 and the neck section 21 and/or the shoulder section 22a of the base portion 20, together enable the coupler 10, the base portion 20, the enclosure 30, and/or the switch device 90 and the conductor 85 to constitute a sealed structure that effectively prevents moisture, water, dust or other similar foreign materials from invading into or accumulating in the switch device and the quick coupling mechanism.

In an operable embodiment, the operator may operate the coupler 10 for moving the unlocked symbol or position on the coupler 10 to a location corresponding to the non-threaded section 94 of the switch device 90, so that the coupler 10 can be assembled to the shell 98 of the switch device 90. At this point, the contact elements 96 of the switch device 90 are correspondingly plugged into the spring clip structures 51 of the wiring components 50.

When the operator rotates the coupler 10 to force the retaining structures 13 on the coupler 10 to screw to the mating retaining zones 93 to form a locked state or position, the waterproof quick coupling mechanism of the present invention and the conductor 85 are fixedly connected to the switch device 90, providing the switch device and the quick coupling mechanism with the advantageous effects of easy to operate and maintain as well as being waterproof and dustproof.

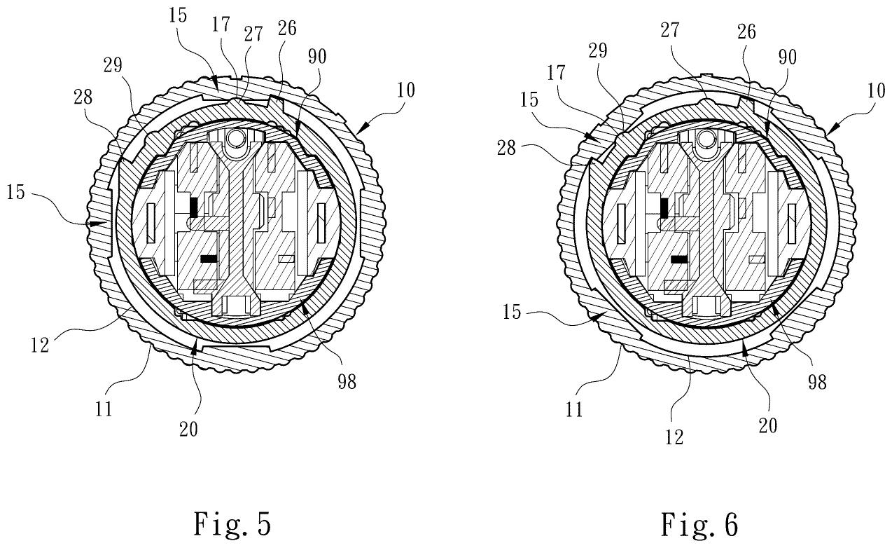

Please refer to FIG. 5 that is a cross sectional view showing the assembly of the coupler 10 and the base portion 20 when the unlocked symbol on the coupler 10 is moved to the position corresponding to the non-threaded section 94 of the switch device 90. At this point, the anti-loosening structures 15 of the coupler 10 is stopped by the primary stopper 26, preventing the coupler 10 from rotating clockwise (when viewing in front of the drawing), and the fitting section 17 is engaged with the primary limiting section 27 to form a mechanism for locating the waterproof quick coupling mechanism of the present invention and the switch device 90 to the unlocked position.

Please refer to FIG. 6. When the operator rotates the coupler 10 counterclockwise (when viewing in front of the drawing) to force the retaining structures 13 on the coupler 10 to screw to the mating retaining zones 93 to form the locked state or position, the anti-loosening structures 15 are stopped by the secondary stoppers 28 and the fitting section 17 is engaged with the secondary limiting section 29 to form a mechanism for locating the waterproof quick coupling mechanism of the present invention and the switch device 90 to the locked position.

It can be found the retaining structures 13 and the anti-loosening structures 15 (and/or the fitting section 17) provided on the coupler 10 are associated with the mating retaining zones 93 of the switch device 90, and the primary limiting section 27 and the secondary limiting section 29 (and/or the primary stopper 26 and the secondary stopper 28) of the base portion 20, respectively, to together enable quick and secured connection of the waterproof quick coupling mechanism and/or the conductor 85 with the switch device 90, or to enable the operator to disconnect the waterproof quick coupling mechanism from the switch device 90 conveniently. With the present invention, it is able to avoid the disadvantages in the conventional quick coupler for switch device, such as loosening or separating of the switch device from the quick coupler due to external factors or vibration of electrical appliances over a long term, as well as troublesome wiring, assembling and maintenance.

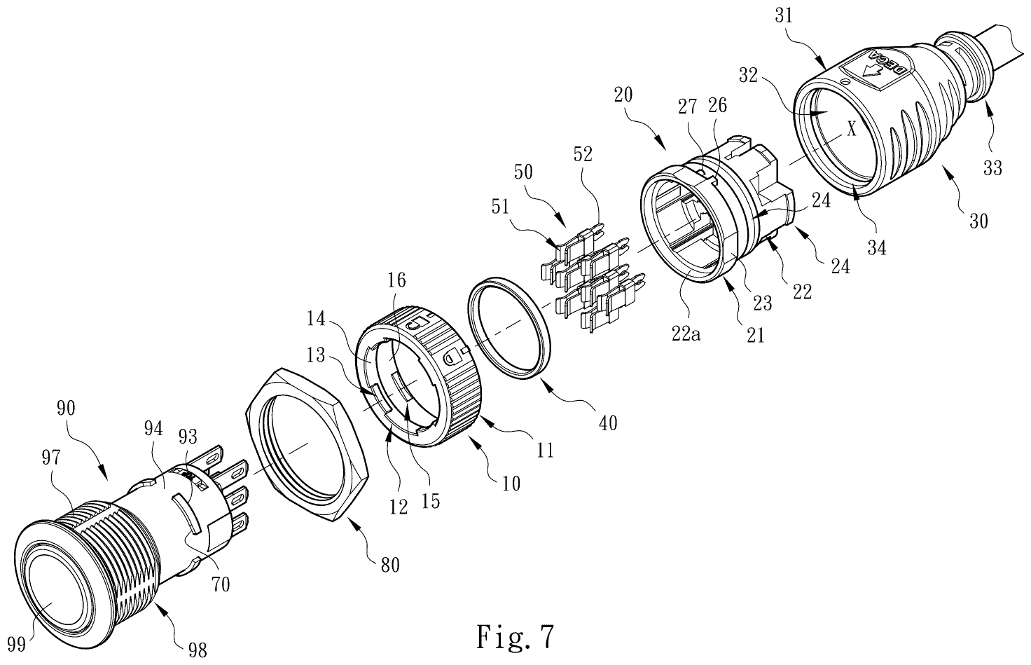

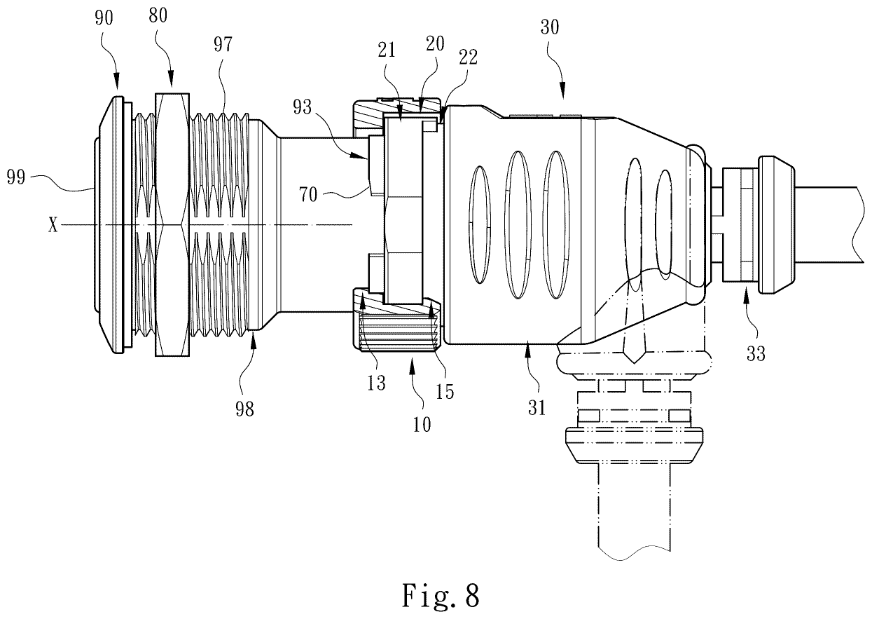

FIG. 7 is an exploded perspective view showing a derivative embodiment of the present invention; and FIG. 8 is an assembled side view of FIG. 7. In the derivative embodiment shown in FIGS. 7 and 8, the coupler 10 includes retaining structures 13, which are respectively in the form of an elongated rib and are circumferentially spaced by recesses 14; and the switch device 90 is provided with mating retaining zones 93, which are respectively an elongated rib and are circumferentially spaced by non-threaded sections 94 to correspond to the retaining structures 13 and the recesses 14. With these arrangements, the retaining structures 13 of the coupler 10 can be quickly connected to or disconnected from the switch device 90.

In the above derivative embodiment, a beveled guide surface 70 is formed at an upper front edge or a lower front edge of each rib-shaped mating retaining zone 93 or each rib-shaped retaining structure 13. When the operator assembles the retaining structures 13 with the mating retaining zones 93, the retaining structures 13 can move along the beveled guide surfaces 70 to be tightly fitted on the mating retaining zones 93.

FIG. 8 includes some imaginary lines that depict the tail portion 33 of the enclosure 30 can be formed into an L-shaped structure.

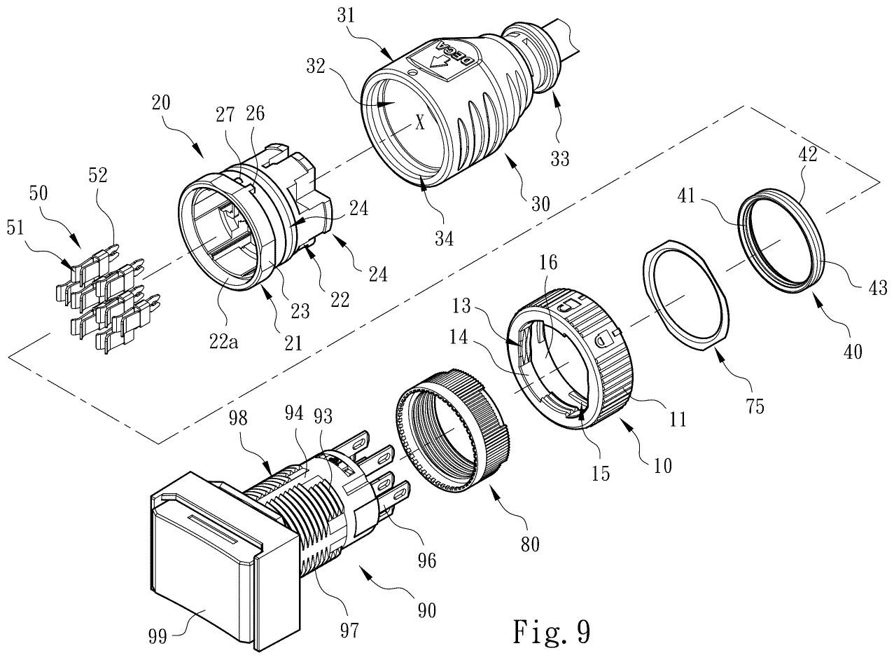

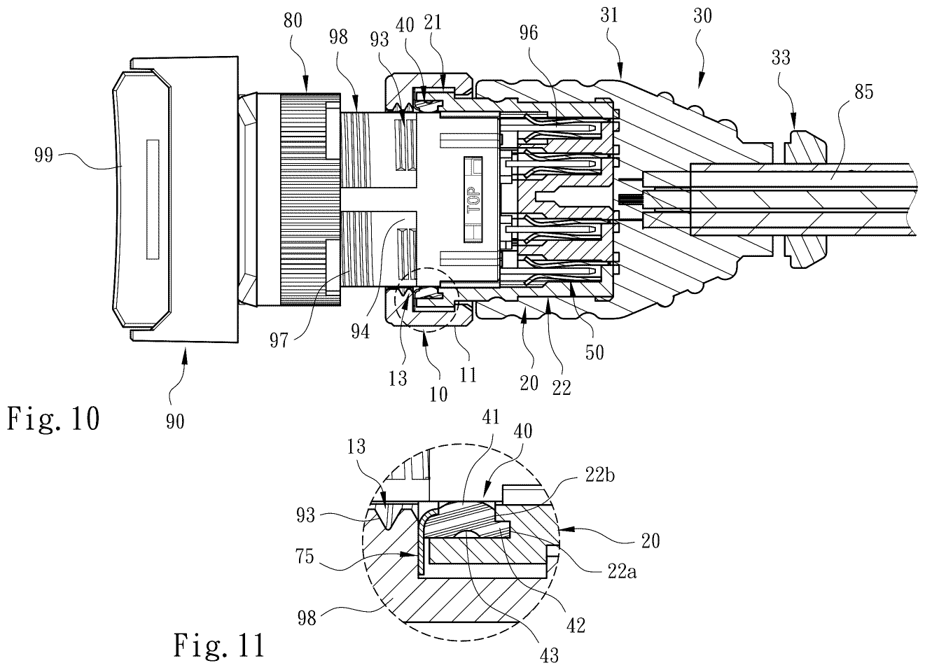

Please refer to FIGS. 9, 10 and 11, which shows a modified embodiment of the present invention. In this modified embodiment, as can be seen in the sectional side views shown in FIGS. 10 and 11, the watertight ring 40 includes a middle portion 41, two wing portions 42 connected to two sides of the middle portion 41, and a dent portion 43 located between the two wing portions 42. And, the base portion 20 further includes a secondary shoulder section 22b connected to the shoulder section 22a. The watertight ring 40 fitted in the base portion 2 is pressed against and held to the shoulder section 22a and the secondary shoulder section 22b.

In the above modified embodiment, the present invention further includes a locating washer 75 located between the coupler 10 and the base portion 20. The locating washer 75 has a generally L-shaped cross section. When connecting or removing the coupler 10 to or from the base portion 20 and/or the switch device 90, the locating washer 75 helps fixing the watertight ring 40 to a correct location. The dent portion 43 of the watertight ring 40 not only provides the watertight ring 40 with a space or function for elastic deformation when the watertight ring 40 is tightly fitted between the coupler 10 and the base portion 20, but also allows the forming of a tight combination between the watertight ring 40 or the middle portion 41 thereof and the shell 98 of the switch device 90.

Generally speaking, in the premise of meeting the requirement of easy to operate, the waterproof quick coupling mechanism for switch device according to the present invention has taken the following factors into consideration and provides the following advantages, compared to the prior art:
(1) The coupler 10, the base portion 20, the enclosure 30, and other related cooperating structures have been redesigned. For example, the coupler 10 is provided with the retaining structures 13, the recesses 14 located between adjacent retaining structures 13, the anti-loosening structures 15, and the secondary recesses 16 located between adjacent anti-loosening structures 15; the base portion 20 is provided with the neck section 21, the tummy section 22 connected with the neck section 21, the primary and the secondary stopper 26, 28 for limiting the rotatable range of the coupler 10, the primary and the secondary limiting section 27, 29 for locating the anti-loosening structures 15 of the coupler 10 in place; and/or the switch device 90 is provided with the mating retaining zones 93 and the beveled guide surface 70; a watertight ring 40 and a locating washer 75 are provided between the coupler 10 and the base portion 20; and the base portion 20 and the conductor 85 are integrally covered and protected by the enclosure 30. All these structural designs are clearly distinct from the prior art and largely change the manner in which the quick coupling mechanism for switch device is used and operated.
(2) Particularly, the coupler 10, the base portion 20, and the enclosure 30 together provide a waterproof quick coupling mechanism, which can be firmly connected to the switch device 90 and allows the operator to quickly disconnect it from the switch device 90 to overcome the problem in the prior art, that is, the switch device tends to become loosened or separated from the quick coupler due to some external factors or frequent vibration of the electric appliance in use over a long time. The waterproof quick coupling mechanism formed by the coupler 10, the base portion 20, and the enclosure 30 of the present invention for connecting with a switch device 90 can also effectively prevent moisture, water, dust and other similar foreign materials from invading into or accumulating in the quick coupling mechanism and the switch device via any gap between them to thereby minimize the possible reverse influences of these foreign materials on the operation stability or safety in use of the switch device.

According to the above discussion, the waterproof quick coupling mechanism for switch device provided according to the present invention has a spatial configuration different from that of the prior art and has advantages that have no parallel in the prior art to show significant improvement compared to the prior art. Therefore, the present invention fully meets the requirements of novelty and improvement for granting a patent.

It is also understood the present invention has been described with some preferred embodiments that are not intended to limit the scope of the present invention in any way. Many changes and modifications in the described embodiments can be carried out without departing from the scope and the spirit of the invention that is intended to be limited only by the appended claims.

What is claimed is:

1. A waterproof quick coupling mechanism for switch device, comprising a base portion (20) for receiving wiring components (50) therein, a coupler (10) rotatably assembled to the base portion (20), and an enclosure (30) integrally covering the base portion (20); wherein the coupler (10), the base portion (20) and the enclosure (30) together define an axis (X);
the coupler (10) having an outer wall (11) and an inner wall (12), and the inner wall (12) of the coupler (10) being provided with retaining structures (13) and anti-loosening structures (15);
the base portion (20) including a neck section (21), a tummy section (22) connected to the neck section (21), and a shoulder section (22a) formed between the neck section (21) and the tummy section (22);
the base portion (20) being provided at positions corresponding to the anti-loosening structures (15) of the coupler (10) with at least one of a stopper and a limiting section; and the coupler (10) and the base portion (20) having a watertight ring (40) provided between them; and the watertight ring (40) being pressed against the shoulder section (22a); and
the enclosure (30) having a head portion (31) and a tail portion (33) connected with the head portion (31); the head portion (31) defining an internal space (32) for receiving the tummy section (22) of the base portion (20) therein; and the tail portion (33) of the enclosure (30) being fitted around a conductor (85).

2. The waterproof quick coupling mechanism for switch device as claimed in claim 1, wherein the retaining structures (13) of the coupler (10) can be assembled to mating retaining zones (93) provided on a switch device (90), such that the switch device (90) is electrically connected with the conductor (85);
the switch device (90) including an operation section (99) and a shell (98) assembled to the operation section (99); the shell (98) having a conductive module and a plurality of contact elements (96) received therein; and the contact elements (96) being outward protruded from a rear end of the shell (98); and
the shell (98) being provided on an outer surface with threads (97) for a fixing ring (80) to screw thereto; the mating retaining zones (93) being in a form selected from the group consisting of partially threaded zones and elongated ribs; and a non-threaded section (94) being formed between and connected to any two adjacent mating retaining zones (93).

3. The waterproof quick coupling mechanism for switch device as claimed in claim 1, wherein the retaining structures (13) are circumferentially equally spaced along a front area of the inner wall (12) of the coupler (10);
the retaining structures (13) being protruded toward the axis (X), and a recess (14) being formed on the inner wall (12) of the coupler (10) between any two adjacent retaining structures (13);
the anti-loosening structures (15) being circumferentially equally spaced along a rear area of the inner wall (12) of the coupler (10) in correspondence with the retaining structures (13); the anti-loosening structures (15) being protruded toward the axis (X); and a secondary recess (16) being formed on the inner wall (12) of the coupler (10) between any two adjacent anti-loosening structures (15); and
the neck section (21) of the base portion (20) having a diametrical size larger than that of the tummy section (22), and the neck section (21) having flat faces (23) formed on its outer surface.

4. The waterproof quick coupling mechanism for switch device as claimed in claim 2, wherein the retaining structures (13) are circumferentially equally spaced along a front area of the inner wall (12) of the coupler (10);
the retaining structures (13) being protruded toward the axis (X), and a recess (14) being formed on the inner wall (12) of the coupler (10) between any two adjacent retaining structures (13);
the anti-loosening structures (15) being circumferentially equally spaced along a rear area of the inner wall (12) of the coupler (10) in correspondence with the retaining structures (13); the anti-loosening structures (15) being protruded toward the axis (X); and a secondary recess (16) being formed on the inner wall (12) of the coupler (10) between any two adjacent anti-loosening structures (15); and
the neck section (21) of the base portion (20) having a diametrical size larger than that of the tummy section (22), and the neck section (21) having flat faces (23) formed on its outer surface.

5. The waterproof quick coupling mechanism for switch device as claimed in claim 3, wherein the retaining structures (13) are in a form selected from the group consisting of partially threaded structures and radially protruded elongated ribs, and the anti-loosening structures (15) being in the form of radially protruded elongated structures; and
the coupler (10) being provided on the outer wall (11) with an unlocked symbol and a locked symbol.

6. The waterproof quick coupling mechanism for switch device as claimed in claim 4, wherein the retaining structures (13) are in a form selected from the group consisting of partially threaded structures and radially protruded elongated ribs, and the anti-loosening structures (15) being in the form of radially protruded elongated structures; and
the coupler (10) being provided on the outer wall (11) with an unlocked symbol and a locked symbol.

7. The waterproof quick coupling mechanism for switch device as claimed in claim 1, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structures and radially inward recessed structures.

8. The waterproof quick coupling mechanism for switch device as claimed in claim 3, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structures and radially inward recessed structures.

9. The waterproof quick coupling mechanism for switch device as claimed in claim 5, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structures and radially inward recessed structures.

10. The waterproof quick coupling mechanism for switch device as claimed in claim 2, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structure and radially inward recessed structure.

11. The waterproof quick coupling mechanism for switch device as claimed in claim 4, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structure and radially inward recessed structure.

12. The waterproof quick coupling mechanism for switch device as claimed in claim 6, wherein the base portion (20) is provided on an outer surface, at where the neck section (21) and the tummy section (22) are connected, with a primary stopper (26) and a secondary stopper (28), which are radially outward protruded structures; and
the base portion (20) further having a primary limiting section (27) and a secondary limiting section (29) provided between the primary stopper (26) and the secondary stopper (28); and the primary and the secondary limiting section (27), (29) being selected from the group consisting of radially outward protruded structure and radially inward recessed structure.

13. The waterproof quick coupling mechanism for switch device as claimed in claim 1, wherein the wiring components (50) respectively have an end configured as a spring clip structure (51) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

14. The waterproof quick coupling mechanism for switch device as claimed in claim 3, wherein the wiring components (50) respectively have an end configured as a spring clip structure (51) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

15. The waterproof quick coupling mechanism for switch device as claimed in claim 5, wherein the wiring components (50) respectively have an end configured as a spring clip structure (51) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

16. The waterproof quick coupling mechanism for switch device as claimed in claim 2, wherein the wiring components (50) respectively have an end configured as a spring clip structure (51) for clipping the contact elements (96) of the switch device (90) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

17. The waterproof quick coupling mechanism for switch device as claimed in claim 4, wherein the wiring components (50) respectively have an end configured as a spring clip structure (51) for clipping the contact elements (96) of the switch device (90) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

18. The waterproof quick coupling mechanism for switch device as claimed in claim 6, wherein the wiring components (50) respectively have an end configured as a spring clip structure (51) for clipping the contact elements (96) of the switch device (90) and another end configured as a clamp structure (52);
the base portion (20) being provided at a bottom of the tummy section (22) with cuts (25), via which the clamp structures (52) of the wiring components (50) are extended to be movably connected to the conductor (85);
the tummy section (22) being provided on an outer surface with scarf joining sections (24), which are selected from the group consisting of corrugated structures and recessed structures; and
the enclosure (30) being formed on an inner wall of the head portion (31) with a fitting structure (34) for engaging with the scarf joining sections (24) of the base portion (20); and the tail portion (33) of the enclosure (30) having a configuration selected from the group consisting of a straight structure extending parallel to the axis X and an L-shaped structure.

19. The waterproof quick coupling mechanism for switch device as claimed in claim 7, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position;
and the coupler (10) being stopped from rotating counterclockwise any further when the anti-loosening structure (15) is stopped by the secondary stopper (28) and the fitting section (17) is engaged with the secondary limiting section (29) to thereby form a mechanism for locating the coupler (10) and the switch device (90) at a locked position.

20. The waterproof quick coupling mechanism for switch device as claimed in claim 8, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position;
and the coupler (10) being stopped from rotating counterclockwise any further when the anti-loosening structure (15) is stopped by the secondary stopper (28) and the fitting section (17) is engaged with the secondary limiting section (29) to thereby form a mechanism for locating the coupler (10) and the switch device (90) at a locked position.

21. The waterproof quick coupling mechanism for switch device as claimed in claim 9, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position; and the coupler (10) being stopped from rotating counterclockwise any further when the anti-loosening structure (15) is stopped by the secondary stopper (28) and the fitting section (17) is engaged with the secondary limiting section (29) to thereby form a mechanism for locating the coupler (10) and the switch device (90) at a locked position.

22. The waterproof quick coupling mechanism for switch device as claimed in claim 10, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position; and the coupler (10) being rotatable counterclockwise for the retaining structures (13) of the coupler (10) to screw to the mating retaining zones (93) until the anti-loosening structure (15) of the coupler (10) is stopped by the secondary stopper (28) and the fitting section (17) is engaged with the secondary limiting section (29) to thereby formed a mechanism for locating the coupler (10) and the switch device (90) at a locked position.

23. The waterproof quick coupling mechanism for switch device as claimed in claim 11, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position; and the coupler (10) being rotatable counterclockwise for the retaining structures (13) of the coupler (10) to screw to the mating retaining zones (93) until the anti-loosening structure (15) of the coupler (10) is stopped by the secondary stopper (28) and the fitting section (17) is engaged with the secondary limiting section (29) to thereby formed a mechanism for locating the coupler (10) and the switch device (90) at a locked position.

24. The waterproof quick coupling mechanism for switch device as claimed in claim 12, wherein one of the anti-loosening structures (15) is provided with a fitting section (17), which can be one of a radially outward recessed structure and a radially inward protruded structure; the coupler (10) being stopped from rotating clockwise any further when the anti-loosening structure (15) of the coupler (10) is stopped by the primary stopper (26) and the fitting section (17) is engaged with the primary limiting section (27) to thereby form a mechanism for locating the coupler (10) and the switch device (90) at an unlocked position; and the coupler (10) being rotatable counterclockwise for the retaining structures (13) of the coupler (10) to screw to the mating retaining zones (93) until the anti-loosening structure (15) of the coupler (10) is stopped by the secondary stopper (28) and the fitting section (17) is engaged with the secondary limiting section (29) to thereby formed a mechanism for locating the coupler (10) and the switch device (90) at a locked position.

25. The waterproof quick coupling mechanism for switch device as claimed in claim 1, wherein the retaining structures (13) of the coupler (10) are in the form of elongated ribs, and the elongated rib-shaped retaining structures (13) respectively having a beveled guide surface (70) formed at one of an upper front edge and a lower front edge of each elongated rib.

26. The waterproof quick coupling mechanism for switch device as claimed in claim 3, wherein the retaining structures (13) of the coupler (10) are in the form of elongated ribs, and the elongated rib-shaped retaining structures (13) respectively having a beveled guide surface (70) formed at one of an upper front edge and a lower front edge of each elongated rib.

27. The waterproof quick coupling mechanism for switch device as claimed in claim 5, wherein the retaining structures (13) of the coupler (10) are in the form of elongated ribs, and the elongated rib-shaped retaining structures (13) respectively having a beveled guide surface (70) formed at one of an upper front edge and a lower front edge of each elongated rib.

28. The waterproof quick coupling mechanism for switch device as claimed in claim 2, wherein the retaining structures (13) of the coupler (10) are in the form of elongated ribs, and the mating retaining zones (93) of the switch device (90) are also in the form of elongated ribs; and
either the elongated rib-shaped mating retaining zones (93) or the elongated rib-shaped retaining structures (13) being provided at their upper front edges or lower front edges with a beveled guide surface (70).

29. The waterproof quick coupling mechanism for switch device as claimed in claim 4, wherein the retaining structures (13) of the coupler (10) are in the form of elongated ribs, and the mating retaining zones (93) of the switch device (90) are also in the form of elongated ribs; and
either the elongated rib-shaped mating retaining zones (93) or the elongated rib-shaped retaining structures (13) being provided at their upper front edges or lower front edges with a beveled guide surface (70).

30. The waterproof quick coupling mechanism for switch device as claimed in claim 6, wherein the retaining structures (13) of the coupler (10) are in the form of elongated ribs, and the mating retaining zones (93) of the switch device (90) are also in the form of elongated ribs; and
either the elongated rib-shaped mating retaining zones (93) or the elongated rib-shaped retaining structures (13) being provided at their upper front edges or lower front edges with a beveled guide surface (70).

31. The waterproof quick coupling mechanism for switch device as claimed in claim 1, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.

32. The waterproof quick coupling mechanism for switch device as claimed in claim 3, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.

33. The waterproof quick coupling mechanism for switch device as claimed in claim 5, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.

34. The waterproof quick coupling mechanism for switch device as claimed in claim 2, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.

35. The waterproof quick coupling mechanism for switch device as claimed in claim 4, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.

36. The waterproof quick coupling mechanism for switch device as claimed in claim 6, wherein the watertight ring (40) includes a middle portion (41), two wing portions (42) connected with the middle portion (41), and a recessed portion (43) located between and connected with the two wing portions (42);
the base portion (20) further including a secondary shoulder section (22b) connected with the shoulder section (22a), and the watertight ring (40) being pressed against the shoulder section (22a) and the secondary shoulder section (22b); and
the coupler (10) and the base portion (20) further having a locating washer (75) provided between them; and the locating washer (75) having an L-shaped cross section and being used to assist in holding the watertight ring (40) in place.
